(19) United States
(12) Patent Application Publication
(10) Pub. No.: US 2024/0419782 A1
(43) Pub. Date: Dec. 19, 2024

(54) SECURE ELEMENT WITH OPTIMIZED BYTECODE

(71) Applicant: Giesecke+Devrient ePayments GmbH, Munich (DE)

(72) Inventor: Hartmut BECKMANN, Neuried (DE)

(21) Appl. No.: 18/746,267

(22) Filed: Jun. 18, 2024

(30) Foreign Application Priority Data
Jun. 19, 2023 (DE) 102023115984.4

(51) Int. Cl. G06F 21/53; G06F 21/54

(52) U.S. Cl. CPC G06F 21/53; G06F 21/54

(57) ABSTRACT

A secure element is configured to execute bytecode in a runtime environment and/or an applet. The secure element is configured to engage a free bytecode in a bytecode range that is unused according to the programming language specification with a user-defined bytecode. The chip card is furthermore configured to provide an allocation table for converting the user-defined bytecode into a standard bytecode sequence, the conversion taking place according to the context of the use of the user-defined bytecode. The solution permits a memory space saving.

### FIELD OF THE INVENTION

The invention relates to a secure element, in particular a secure element based on Java Card technology, that is configured to execute bytecode in a runtime environment and/or an applet and that permits optimized memory space use by Java bytecode, in particular a chip card. Furthermore, the invention relates to a method for executing bytecode in a runtime environment and/or an applet on a secure element, and to a computer program or applet that can carry out the method.

### TECHNICAL BACKGROUND

Java is a widely used programming language that plays an important part in chip card technology due to its platform independence and its security features. This independence is made possible through the use of a virtual machine (VM) that abstracts the respective hardware vis-à-vis the software applications. Despite their diverse opportunities for use in chip cards, the use of Java applets is restricted, since they do not allow direct memory access, for example. This is a security advantage, however, because it prevents an applet from compromising the operating system (OS) of the chip card or applets of other manufacturers as an introduced virus.

An important aspect of chip card technology is the storage capacity of the chip cards, which has a significant influence on pricing. The operating system of the chip card already occupies a large part of the memory. The little memory that remains can be used for customer-specific applets. Careful design and refined implementations could substantially reduce the memory requirement for the operating system given the same scope of functions. Such an approach opens up potential economic advantages, either in the form of higher profit margins or as a competitive advantage through lower prices.

An important method for saving memory space is bytecode optimization. Java uses bytecodes, short command sequences, of which there are 223 different types. Additionally, there are 33 free bytecodes that can be used to define separate commands. To be able to execute these free bytecodes, the VM needs to be expanded.

A known approach for bytecode optimization defines the free bytecodes as short forms of longer bytecodes and calls them “optimized bytecodes” (OBC). An example of this is the instruction to increase a counter by 1, which is implemented by an optimized bytecode that is recognized in the VM and reduced to a general addition. This approach saves approximately 8% of memory space in practice, which represents a significant contribution to memory saving.

The known approaches have disadvantages, however.

An independence between the operating system and applets with respect to the use of optimized bytecode is not guaranteed, which limits potential memory savings. Additionally, applets with optimized bytecode can be installed only on an operating system that implements the same optimized bytecode, leading to increased maintenance and administration effort and to the need for multiple functionally identical applet versions. Moreover, effective bytecode optimization of an applet can necessitate work-intensive and not always practical adjustment of the operating system for the bytecode of the applet in order to save the maximum possible memory space.

U.S. Pat. No. 5,905,895 A describes a concept for optimizing “non-native” bytecode, e.g. Java bytecode, before it is interpreted. However, the concept described permits only a limited memory space reduction, in particular because the size of the optimized bytecode is only slightly smaller than that of the original bytecode.

### OBJECT OF THE INVENTION

The invention is based on the object of providing a concept that permits an effective memory space reduction by applets executed on a secure element/chip card/smartcard, the dependence between applets and the operating system being reduced.

### SUMMARY OF THE INVENTION

The object is achieved by a secure element according to claim 1 and a method and a computer program or applet according to claims 14 and 15.

Some of the terms used in this application are explained briefly below.

The term “secure element” is synonymous with the term “UICC”, “eUICC”, “iUICC”, “subscriber identity module”, “chip card”, “iUICC”, “integrated eUICC”, “integrated secure element”, “embedded secure element”, “secure element”, “SIM”, “eSIM” or “iSIM”. Secure element is also intended to be understood to mean USIM, TSIM, ISIM, CSIM or R-UIM.

A secure element, SE for short, for the purposes of the invention is an electronic module that has a reduced physical size and level of resources and that has a control unit (microcontroller) and at least one interface (data interface) for communication with instances outside the secure element, such as terminals, servers, etc. This communication is preferably carried out using a connection protocol, in the case of a secure element in particular a protocol based on the ETSI TS 102 221 or ISO-7816 standard.

The secure element may also be a software component in a trusted part of an operating system, a so-called trusted execution environment, TEE for short, of the device. The secure element is formed for example within a secure runtime environment in the form of programs running therein, so-called “trustlets”.

The secure element may also be an integral part of a larger integrated circuit, for example of a modem or application processor. Such UICCs are referred to as “integrated UICCs”, “integrated TREs”, “integrated eUICCs” or “Integrated SEs”. Secure elements such as these are permanently integrated into an SoC as an integrated processor block and can be linked by way of a chip-internal bus.

The secure element can be used for the remote monitoring, remote control and remote maintenance of devices such as machines, plants and systems. It can be used for metering units such as electricity meters, hot water meters, etc. The secure element is part of the technology of the IoT, for example.

The SE may also be an integral part of a larger integrated circuit, for example of a modem or application processor. Such SEs are referred to as “integrated UICCs”, “integrated TREs”, “integrated eUICCs” or “Integrated SEs”. Such SEs are permanently integrated into an SoC as an integrated processor block and can be linked by way of a chip-internal bus. The SE has an internal or external secure nonvolatile memory area, for example, into which the identity data have been securely introduced in order to prevent manipulation and/or misuse attempts during the identification and/or authentication on the network.

In one refinement, the SE may be operative by means of a terminal, the SE in this refinement being self-sufficient apart from supply signals, such as supply voltage, clock, reset, etc. The SE may then have an interface (data interface) for communication with the terminal into which the SE has been introduced, possibly in operational form. This communication is preferably carried out using a connection protocol, in particular a protocol based on the ETSI TS 102 221 or ISO-7816 standard.

The term “terminal” is preferably used here because the terminal in communications technology may primarily be a terminal. This does not preclude the “terminal” from being a “device” in another technology. The terms “terminal” and “device” are used synonymously herein.

The SE can be used for the remote monitoring, remote control and remote maintenance of devices such as machines, plants and systems. It can be used for metering units such as electricity meters, hot water meters, etc. The SE is part of the technology of the IoT, for example.

A terminal for the purposes of the invention is basically a device or a device component having means for communication with a communication network in order to be able to use services of the communication network or in order to be able to use services of a server via a gateway of the communication network. By way of example, a mobile terminal such as a smartphone, a tablet PC, a notebook or a PDA is intended to be covered by the term. A terminal can also be understood to mean for example multimedia devices such as digital picture frames, audio devices, television sets and e-book readers, which likewise have means for communication with the communication network.

In particular, the terminal has been introduced into a machine, an automaton and/or a vehicle. If the terminal has been introduced into a motor vehicle, it has incorporated an SE, for example. The SE can use the terminal, for example a modem of the terminal, to set up a data connection to a server via the communication network. The terminal can be used to contact for example a server of the terminal manufacturer in order to address control units, e.g. ECUs (ECU=Electronic Control Unit), for functionalities of the terminal. The UICC can be used to contact a server in the background system of the mobile network operator, MNO, for example a server, in order to load updates for software, firmware and/or the operating system of the SE into the SE.

Mobile-radio-compatible terminals include not only smartphones and cell phones but also automatic control devices (control devices or measuring devices or combined control/measuring devices) for industrial facilities in the commercial or private sector. Industrial facilities are for example production plants that have one or more automatic control devices (terminals) that can communicate with a background system and/or with one another via a mobile radio network. Other industrial facilities are smart home facilities, e.g. heating systems or loads with terminals in the form of automatic control devices.

The secure element could be part of an Internet of Things, IoT, device, in particular using Java applets (or a different bytecode). IoT devices are possibly mass-produced goods, thus very price-sensitive and therefore subject to memory space restrictions.

Chip card as an example of a secure element denotes a card having a built-in microchip. This may perform different functions, e.g. process data and/or provide memory functionality. The microchip may comprise a memory such as RAM or flash memory and/or a digital signal processor (DSP) and/or an application-specific integrated circuit (ASIC).

Smartcard denotes a card having a built-in microprocessor that can perform more complex functions compared with the microchip, for example cryptographic operations.

Applet denotes a small program, preferably a Java program, that is executed on a secure element and performs specific tasks, e.g. a payment transaction or managing identification information.

Virtual machine (VM) denotes a software that permits commands programmed on the hardware of the secure element to be executed independently of specific hardware details.

Java virtual machine (JVM) denotes a software that permits the execution of Java applets on the secure element by converting Java bytecode into machine-readable instructions.

Runtime environment denotes a software that provides programs or applications with services and resources, permits their interaction with the operating system and the hardware and manages the execution of the program code. It generally comprises functions for memory management, error handling and interaction with the operating system.

Java Card, in the hardware context, denotes a smartcard or chip card that provides a Java runtime environment and can execute Java applets, and, in the software context, denotes an open application development framework and a technology specification that permit the development and use of Java applications (Java Card applets) on smartcards and chip cards.

Bytecode denotes a special form of digital instructions that can be executed by a virtual machine (VM). Bytecode is platform-independent and can be executed on any hardware that has an appropriate VM. Each instruction is generally at least one byte or multiple bytes long. Bytecode is therefore compact and space-saving, which is important particularly in the case of limited-resource systems such as secure elements, for example chip cards.

Free bytecode denotes a bytecode command that is not used in the current system implementation and is thus available for defining special or user-defined commands.

Optimized bytecode is a special version of bytecode that uses more efficient or more compact commands in order to save memory space. In Java programming, e.g. unused bytecodes can be used to shorten frequent command patterns and therefore represent them more efficiently. The use of optimized bytecodes requires adjustments in the virtual machine in order to correctly interpret and execute these new instructions.

The punctuation mark “/” (oblique stroke) is understood to mean “or”.

One aspect of the invention relates to a secure element, in particular a chip card, that is configured to execute bytecode. The secure element is configured to execute the bytecode in a runtime environment and/or an applet on the secure element. The secure element is configured to engage a free bytecode in a bytecode range that is unused according to the specification of the programming language as a user-defined bytecode and to provide an allocation table for converting the user-defined bytecode into a standard bytecode sequence comprising at least one standard bytecode, the conversion taking place according to the context of the use of the user-defined bytecode. These features of the secure element, in particular the assignment of a user-defined bytecode to a free bytecode, have the technical effect of saving memory space. A standard bytecode sequence can consist of one or more standard bytecodes.

Another aspect of the invention relates to a method for executing bytecode in a runtime environment and/or an applet on a secure element. The method comprises engaging a free bytecode in a bytecode range that is unused according to the specification of the programming language as a user-defined bytecode, and providing an allocation table for converting the user-defined bytecode into a standard bytecode sequence comprising at least one standard bytecode, the conversion taking place according to the context of the use of the user-defined bytecode. In this step, the free bytecode is assigned to a user-defined bytecode. This allocation achieves a memory space saving.

Another aspect of the invention relates to a computer program or applet that carries out the method described above when the computer program or applet is loaded into the memory of a secure element as described previously and/or is executed on the secure element.

The features and mechanisms associated with the described aspects of the invention are described hereinbelow.

Bytecode is a form of a command set designed for efficient execution by a software interpreter such as a virtual machine. The executability of bytecode on the secure element means that the secure element can execute applications that i) have been coded in a high-level language such as Java and then translated into bytecode or ii) are coded directly in bytecode, at least in part.

The secure element is configured to execute bytecode in a runtime environment and/or an applet on the secure element. This comprises the following aspects:

If the bytecode is executed in the applet, this can happen if the applet is called on the basis of a particular event. The applet then operates as part of the runtime environment, which provides the services and resources that the applet needs.

If the bytecode is executed in the runtime environment, it is not tied to a particular user event and may be part of the operations at system level of the secure element. This may comprise the initialization of the card, the management of resources or the performance of security operations.

The execution of bytecode both in the runtime environment and in the applet suggests a layered execution structure in which bytecode can be executed both at system level in the runtime environment and at application level in the applet. This hierarchic structure permits structured and efficient execution of tasks and functions on the secure element.

The secure element is configured to engage a free bytecode in a bytecode range that is unused according to the specification of the programming language as a user-defined bytecode and to provide an allocation table for converting the user-defined bytecode into a standard bytecode sequence comprising at least one standard bytecode, the conversion taking place according to the context of the use of the user-defined bytecode.

Engaging a free bytecode in a bytecode range that is not used according to the specification of the programming language means that the core functionality of the secure element is not impaired or disrupted by this process.

Engaging a free bytecode with a context-dependent implementation in the form of a user-defined bytecode relates to the dynamic nature of the functionality of the secure element. The term implementation relates to overwriting or modifying the bytecode in order to increase execution efficiency. This can mean that the virtual machine or the applet is modified such that the memory imprint of the bytecode (the memory space occupied by the user-defined bytecode) is changed according to the circumstances or the context in which the free bytecode is used. Assigning free bytecode to user-defined bytecode allows the functionality of a standard bytecode having a particular memory requirement to be transferred to a user-defined bytecode having a smaller memory requirement, thereby saving memory space.

Advantageous embodiments of the invention are described hereinbelow. Every embodiment, or the features thereof, can be combined with any other embodiment and/or aspect of the invention, provided that this makes technical sense and/or is technically permissible. As such, for example features that are presented or described as part of one embodiment can be used for or in conjunction with a different embodiment in order to obtain another embodiment.

According to one embodiment, the user-defined bytecode can be labelled as optimized bytecode due to the memory space saving.

According to one embodiment, the programming language may be Java. This produces compatibility and interoperability with a multiplicity of systems and applications, since Java is platform-independent. Advantageously, this can lead to a simpler implementation, broader use of the secure element and greater flexibility, since Java is a widely used programming language with a comprehensive ecosystem of libraries and tools. In this case, the unused bytecode range is preferably a range of hexadecimal values between 0xCA and 0xFF, preferably between 0xCB and 0xFD.

According to one embodiment, the secure element may be a chip card and preferably a Java Card. Preferably, the runtime environment may be a Java runtime environment and/or the programming language specification may be a Java specification. This ensures compatibility with the security-, portability- and object-oriented features of Java and increases the robustness and versatility of the secure element. This configuration can increase the security and interoperability of the secure element with different applications and devices and thus promote broader acceptance and use in different fields and applications.

According to one embodiment, the context may be defined by virtue of the bytecode being in the operating system of the secure element or in an applet loaded onto the secure element. The context, which determines the assignment of a free bytecode, may depend on whether the bytecode is in the operating system of the secure element or in an applet loaded on the secure element.

If the bytecode is within the operating system, the context is recognized as the operating system of the secure element. This means that the specific implementation and interpretation of the assigned bytecode depends on the specific properties and requirements of the operating system of the secure element, which may be significant for the core functionality and the resource management at a higher level.

If the bytecode is within an applet loaded on the secure element, the context is identified as this specific applet. The specific interpretation and implementation of the bytecode then depends on the specific requirements of the applet. Since applets often perform specialized tasks compared with the operating system, this distinction permits more selective optimizations that meet the requirements of the respective applet.

This approach therefore provides a flexible system in which the assignment of free bytecodes can be fine-tuned according to the specific requirements of the operating system or of an applet, the context-dependent assignment process being able to be used to boost efficiency and performance.

According to one embodiment, the context may comprise a package that contains the bytecode. Preferably, the context may comprise a class to which the bytecode belongs, and/or may be determined by the type of a method that the bytecode is in, the method being able to be in particular an instance method, a constructor or a static method.

In object-oriented programming languages normally used for secure elements, in particular Java or possibly C++, Python or JavaScript, a package is a group of related classes, interfaces and subpackages. If the context is defined as the package that contains the bytecode, the assignment of the free bytecode is determined by the special requirements and properties of this specific package. This can permit tailored memory space savings at package level.

Similarly, a class is a blueprint from which individual objects are produced. If the context is defined as the class to which the bytecode belongs, the user-defined bytecode assigned to the free bytecode depends on the specific requirements of this class. This allows fine-tuned memory space savings that meet the specific requirements of the individual classes to be achieved at class level.

Moreover, the context may also be determined by the type of the method that the bytecode is in. Methods may be instance methods (which belong to an instance of a class), constructors (special methods that are called when a new object is produced) or static methods (which belong to the class itself and not to an arbitrary object). The specific requirements of these different types of methods can deliver an even more detailed level of the context and permit corresponding memory space savings.

By way of example, a constructor method may require a different implementation of a bytecode than a static method, since they play a different part in the object-oriented programming. This embodiment can lead to a corresponding design of the bytecode assignment, which can lead to even better memory use or memory space saving.

According to one embodiment, the secure element may be configured to provide an allocation table or mapping table for converting user-defined bytecode into context-dependent standard bytecode sequences, which determines the realization of the free bytecodes. The allocation table/mapping table plays a crucial part in the conversion of user-defined bytecode, which has been assigned on a context-dependent basis, into standard bytecode sequences, and the user-defined bytecode can be regarded as equivalent to the optimized bytecode. It relates to bytecodes that are in a particular range [0xCA . . . 0xFF], preferably [0xCB . . . 0xFD], which is not used according to the Java specification, but is used here in order to save memory space.

The allocation table is a way of translating the user-defined bytecode back into standard bytecode according to the requirements/definitions of the programming language (in this situation Java). Depending on the context in which a user-defined bytecode is found, the secure element uses the applicable allocation table to convert it back into standard bytecode sequences. This mechanism permits the secure element to assign free bytecode dynamically and efficiently according to the specific requirements of the respective context. As soon as the bytecode has fulfilled its purpose and can be interpreted or executed, the allocation table ensures that it is converted back into standard bytecode. This improves memory use and increases the performance and flexibility of the secure element.

According to one embodiment, the secure element may be configured to use the allocation table to identify different contexts, including i) the operating system of the secure element and/or ii) the applet and/or iii) the package and/or iv) the class and/or the type of the method. This permits a specific engagement of the free bytecodes with user-defined bytecodes.

As already mentioned, a context may be the operating system of the secure element, an applet loaded onto the secure element, a package that contains the bytecode or a class or a method type that contains the bytecode. Each of these contexts can have specific requirements, and the specific implementation assigned to the bytecode can change depending on the context.

The allocation table supports this process by changing user-defined bytecode, which is assigned for optimum memory use depending on the context, back into standard bytecode sequences, the individual bytecodes of which are defined in the programming language. The allocation table also distinguishes between these different contexts and permits specific implementations, which are based on the specific requirements of a particular context.

By way of example, an optimized bytecode used in the context of an operating system can be mapped onto a different standard bytecode, or a different standard bytecode sequence, than the same optimized bytecode used in the context of an applet or a particular class. This context-dependent mapping makes the system flexible and can lead to efficient memory use and better overall performance.

According to one embodiment, the secure element may be configured to carry out combined storage of the allocation table on the secure element, regardless of whether the actual storage location is in the memory area of the context, in order to permit faster access to the bytecodes. In this situation, the feature “combined” relates to the way in which the allocation tables are stored on the secure element. Combined storage relates to a consolidated or standardized form of storage in which allocation tables relating to different contexts are not stored in scattered form or separately in the memory areas of the respective contexts, but rather are brought together at a central location on the secure element.

Although an allocation table may be associated with the respective context, this does not necessarily mean that its actual storage location must be within the memory area of the context. Instead, combined storage can take place within the secure element, which is advantageous for faster access. This means that the secure element is in a form such that the allocation tables that help to convert user-defined bytecodes into standard bytecodes are stored together on the card and are not scattered over different contexts. This permits faster access to the allocation tables and hence to the bytecodes, leading to faster execution and better overall performance.

According to one embodiment, the secure element may be configured to provide a separate allocation table for each applet, given multiple applets, in order to improve memory use and to prevent incompatible combinations of the operating system and applets. This expands the concept of using context-related allocation tables and applies it to a scenario in which multiple applets are involved, each of which has its own requirements and its own behavior. To handle such a scenario efficiently and effectively, the secure element may be designed to provide a separate allocation table for each applet, as a result of which each applet can map its context-specific, user-defined bytecodes to standard bytecodes.

This permits improved memory use. Since each applet receives its own allocation table tailored to its specific requirements, the user-defined bytecodes can be mapped optimally and in memory-saving fashion, as each allocation table deals only with the specific contexts that are relevant to its applet.

Separate allocation tables permit incompatible combinations of the operating system and applets to be avoided, since the risk or probability of incompatibilities between the operating system and applets is reduced. The allocation tables of the individual applets may be independent of one another, thereby ensuring that the bytecode optimizations used in the operating system and in the individual applets are tailored to the needs of the individual applets differently and specifically. This means that no applets optimized specifically for the respective operating system are needed, thereby eliminating or at least reducing the risk of combination errors.

According to one embodiment, the allocation table may comprise difference tables. Changes in the bytecode assignments can be detected relative to a master allocation table. This can improve storage efficiency, since, for memory space saving reasons, it makes no sense to manage a complete allocation table in every context. Each entry in this table can occupy 3-6 bytes, which in turn need to be saved by way of corresponding memory space savings in the actual bytecode of the package, the class, etc. To improve storage efficiency, allocation tables are therefore stored as difference tables.

A difference table is a version of the allocation table that stores only changes or differences in relation to a master allocation table, which is an allocation table of a higher context. This means that the difference tables are used to store not the complete allocation information for each context, but rather only the changes that have been made in this specific context compared with a more general or master context.

This approach improves storage efficiency, as the volume of information to be stored for each context is reduced. Only the differences or changes compared with the more general, superordinate context/master context are stored, rather than all of the allocation information.

This approach permits the smartcard to detect changes in the bytecode assignments. The difference tables permit a fast comparison with the master mapping table or the superordinate context mapping table. If a difference exists, it can easily be detected and corrected.

According to one embodiment, the master allocation table may be a fundamental allocation table that comprises a set of user-defined bytecode assignments that is valid for different contexts. The master allocation table can be used as a basic or standard set of allocations that may be valid for multiple contexts. It is essentially a collection of allocations of user-defined bytecodes to the corresponding standard bytecodes, which are used to save memory space.

Accordingly, the master allocation table may be valid across contexts. Consequently, allocations of bytecodes that are defined in this allocation table can be used in different contexts, unless a particular context has a difference table that overrides these allocations. This approach permits a generalized solution for executing bytecode on the secure element as a whole, and affords a basic functionality that can be specialized for different contexts according to need. It contributes to optimum storage efficiency by avoiding repetition of joint bytecode allocations in different contexts.

According to one embodiment, a difference table may be designed to replace the user-defined bytecode for a context subordinate to the master mapping table (a more specific context, or one nested in another context) with a bytecode that affords higher storage efficiency in this context.

If a bytecode in a particular context, e.g. a class within an applet, is replaced with another bytecode that has higher storage efficiency in this context, this change is recorded in the difference table for this context. Replacing bytecode is used to achieve higher storage efficiency in the respective context. This ensures that each context is individually optimized, leading to altogether better memory use on the secure element as a whole.

The advantage of this approach is that it permits local optimization. Each context can adjust its bytecode allocation in order to achieve the best possible storage efficiency, while the master allocation table continues to be used for general cases. This ensures a balance between storage efficiency and maintainability of the bytecode allocations.

According to one embodiment, the difference table may be in the form of a dense array, the dense array defining a first bytecode value and a last bytecode value, which is overwritten with regard to the next highest context, bytecode values in between likewise being overwritten. A dense array may be a data structure in which all elements between the first and the last are explicitly defined. In connection with the difference table, this means that all bytecode values between the first and the last are overwritten.

The first and last bytecode values relate to the range of bytecodes that are newly defined or overwritten in a particular context compared with the next highest context. All bytecode values that are within this range are likewise overwritten.

The use of a dense array for the difference table has several advantages. First, since all values are explicitly defined and coherently stored, search operations on such an array can be carried out quickly, which is critical for the performance of a secure element. And, secondly, the secure element can achieve an optimum saving of memory space by defining a particular range of bytecodes that are supposed to be overwritten in a context and storing these allocations in a dense array. Dense arrays therefore have advantages in respect of memory space saving and (above all) running time compared with other solutions that are known.

The design of the difference table as a dense array thus permits faster access and better memory use when executing bytecode in different contexts.

According to one embodiment, the dense array may comprise elements that each have 1-byte indices that refer to a field in which the data for the user-defined bytecodes are stored, which implements an efficient redirection mechanism. According to this programming technique, the value of a variable is used not for its direct content but rather as a reference or pointer to another location that contains the actual data or values.

In connection with the difference table, this means that each element of the dense array does not contain the user-defined bytecode directly, but rather a 1-byte index that refers to the location at which the actual bytecode is stored. This type of redirection allows the system to efficiently manage and access the data connected to the optimized bytecodes, since the indices afford a direct and fast path for retrieving the relevant data, and minimizes the memory space needed for storing each index. This mechanism contributes to improved performance and memory optimization for operation of the secure element.

According to one embodiment, the secure element may be configured to use a prioritized allocation process, wherein, for a given context, the respective difference table for the bytecode allocation is first checked and, if no specific allocation is found, the master allocation table is used. This process begins with the context-specific difference table and uses the master allocation table when needed.

The operating system of the secure element has a layered mapping structure with context-specific difference tables and a master mapping table. This allocation table delivers allocations or mappings from the optimized bytecode to the standard bytecode.

For a particular context, the difference table can first be searched. Said table contains mappings that have been optimized specifically for this context. If a mapping for the respective bytecode is found in this table, said mapping is used.

If a specific mapping for the bytecode is not found in the context-specific difference table, the master mapping table is used. This table contains a basic set of user-defined bytecode mappings that are valid for different contexts.

This approach permits the system to use optimized bytecode allocations, which can lead to more efficient operation. At the same time, a valid mapping is guaranteed to always be able to be ascertained, even if an optimized mapping is not available in the context-specific allocation table, which means that the functionality and compatibility of the secure element is maintained across different contexts.

As a result, an improved memory space saving can be ensured within a, preferably every, context, since only the difference in the bytecode mappings compared with the master table needs to be stored for each context, instead of storing a complete mapping table for every context.

According to one embodiment, the secure element may be configured as a secure element module or as a chip card module or as a smartcard or as a secure element module implemented in a housing having a different design than a secure element.

According to one embodiment, the secure element may comprise an operating system, in particular a chip card operating system or a Java Card operating system or a native operating system.

According to one embodiment, the programming language may be MULTOS Executable Language (MEL) or .NET Common Intermediate Language (CIL).

### BRIEF DESCRIPTION OF THE FIGURES

The invention is explained in more detail below on the basis of exemplary embodiments and with reference to the drawing, in which:

FIG. 1 shows the structure of a table for optimized bytecode (OBC) of a chip card according to the prior art;

FIG. 2 shows the structure of the concept according to the invention;

FIG. 3 shows the representation of the “overwriting” of OBCs at different structure levels;

FIG. 4 shows the structure of an OBC (Optimized Bytecode Definition) table according to the invention;

FIG. 5 shows the block diagram of the method according to the invention.

### DETAILED DESCRIPTION OF EXEMPLARY EMBODIMENTS

A known approach to bytecode optimization is for the virtual machine (VM) itself to demand as little additional memory as possible in order to perform the additional functions defined for “free” bytecodes. The free bytecodes simply define shortened forms of longer bytecodes. This represents an optimization, for which reason such bytecodes are also referred to as “optimized bytecodes” (OBC).

An example of this is increasing a counter by 1, which corresponds to adding 1. This occurs frequently. An “optimized bytecode” can therefore be used as follows in order to save memory space (SINC):

“Increase a value by 1” (1 byte)

Index of the variable to be incremented (1 byte)

The special bytecode (SINC) is recognized in the VM and reduced to the execution of the aforementioned general addition of a value to a variable. There is thus no special code in the VM to execute the special bytecode—which would in turn take up memory space—but rather the special bytecode is reduced to “just” a general standard bytecode, which is done using already available means/available code of the VM.

For the example above, this means that the “optimized bytecode” SINC is reduced to an IINC having the value 1.

In general, an optimized bytecode can also represent a sequence of multiple standard bytecodes instead of a single standard bytecode, as described in the example above. The possible memory space saving can therefore be increased further.

In practice, an operating system typically contains 32 kbytes to 100 kbytes of Java bytecode. A Java applet can have between 20 kbytes and 70 kbytes of bytecode (less or more is also possible). Of this, the bytecode optimization used today saves approximately 8% of memory space, which is a very important contribution to the memory space saving.

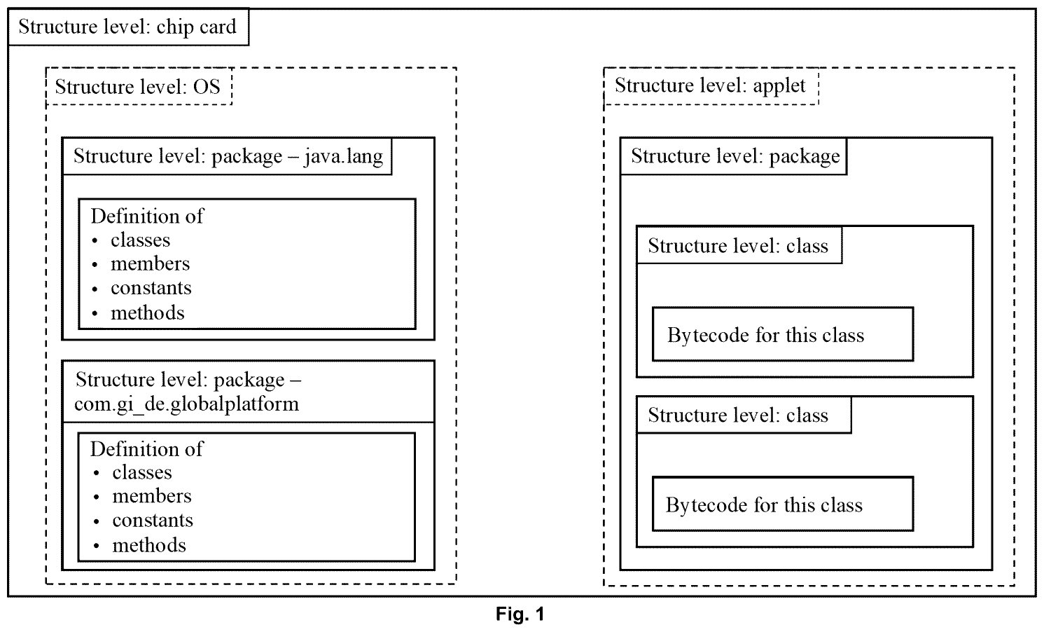

In this respect, the above method (see FIG. 1) has a disadvantage in that the operating system and applets, which should be totally independent of one another per se, are not independent. An applet wishing to use optimized bytecode must use the same “free” bytecode as the operating system also uses. In practice, this means that the memory space gain is frequently limited, since it has been found that the OS and applets would replace largely (˜60%) different bytecodes in order to achieve the best possible optimization.

The aforementioned disadvantage results in yet another disadvantage: if an applet is optimized with regard to the bytecode, this applet can only be installed on an OS that implements exactly the same optimized bytecode. Otherwise, the applet does not work. Throughout product management, it is thus necessary to ensure throughout the (SAP) background system that the applet that exactly matches the OS used is definitely used for variant generation. It is thus always necessary to maintain and hold multiple applet versions that differ only in the type of bytecode optimization but have completely identical functionality.

This means increased effort for maintaining and managing the applets and also additional tests for the correct interaction between the OS and applets (although particularly in the case of Java everything should easily work with everything).

If the bytecode optimization for an applet is particularly effective (e.g. because the applet is very large), it may be necessary to reverse the whole process for business management reasons: it is not the OS that specifies the optimized bytecodes, but rather the applet. Furthermore, an OS is created that uses and implements the optimized bytecodes of the applet to collectively (OS+applet) save the maximum memory possible with this method.

The present invention overcomes the above disadvantages and provides a concept for efficiently optimizing bytecode, specifically within the application of Java on secure elements. The concept is based on the use of “optimized bytecode” that resides in the range [0xCA . . . 0xFF], preferably [0xCB . . . 0xFD], a range that is indicated as being unused in the Java specification.

FIG. 1 presents a general bytecode architecture according to the prior art for a chip card, with the ranges suitable for a bytecode optimization.

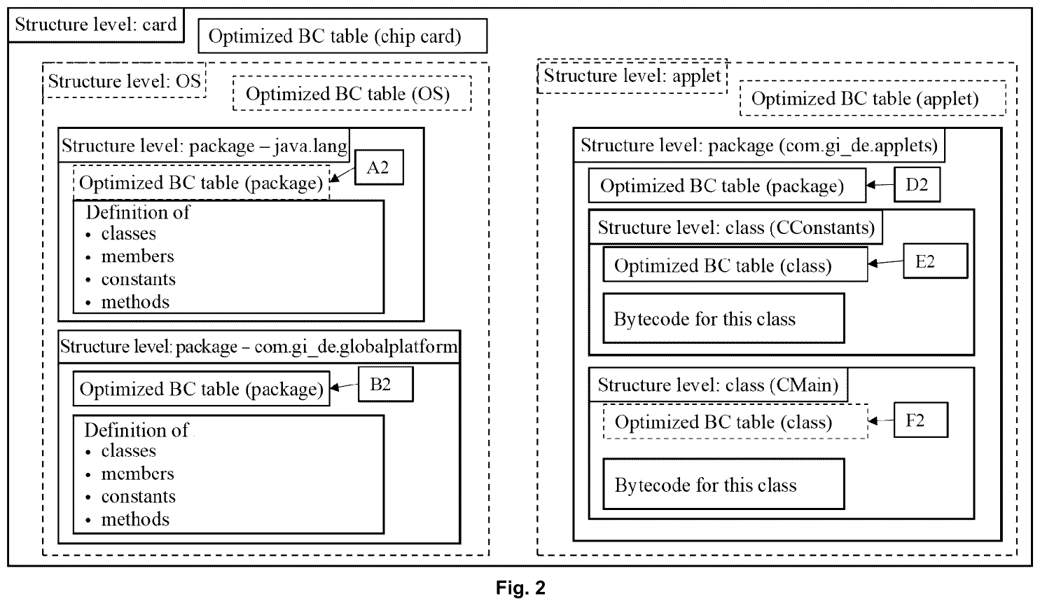

FIG. 2 uses an example of a bytecode architecture of a card to illustrate the concept according to the invention. The basic idea is to make the optimized bytecodes “context-dependent”. As shown in FIG. 2, contexts can be determined by various factors, for example whether a bytecode belongs to the operating system of the card or to an applet stored on the card, which Java package contains a bytecode, or which class a bytecode is in. Other context information could include the type of a method (constructor, normal method or class method) or specific method names in which particular bytecode instructions are frequently used. FIG. 2 illustrates the use of optimized bytecodes according to the respective contexts. The OBC table shown in FIG. 2 is created for the whole Java code of the optimized structure. It is always available.

The numbered references in FIG. 2 should be understood as follows:

A2: Java platform classes such as java.lang classes are often implemented as native functions, and so not much bytecode needs to be optimized. An additional OBC table is therefore pointless as a rule and is omitted.

B2: An optimized OBC may be useful for some specific packages, which e.g. regularly work with calls from security check functions.

D2: In many cases, an applet consists only of a package, and so specific OBCs are defined for the whole package, i.e. the whole applet.

E2: If there is a class that defines many constants, a special OBC table is useful, since only a few bytecodes are used heavily that are otherwise rarely used.

F2: The other classes of the package require no additional OBCs, as the definition at package level is detailed enough.

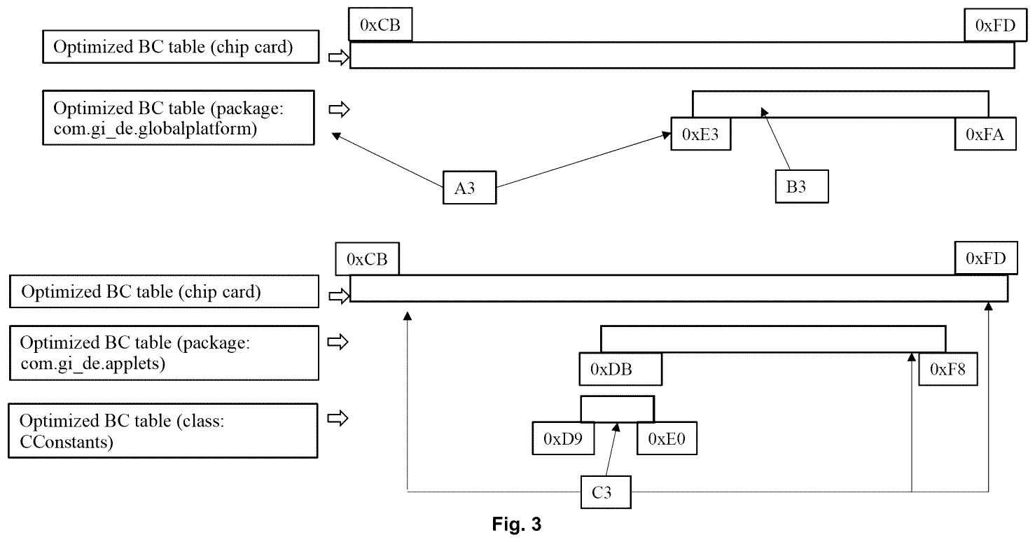

FIG. 3 illustrates the use of allocation tables for implementing these context-dependent bytecodes. Each context has an associated table that defines which optimized bytecodes are converted into which standard bytecodes, or standard bytecode sequences. Each table is context-specific, but must not necessarily be located in the memory area of the respective context.

The numbered references in FIG. 3 should be understood as follows:

A3: In the package com.gi_de.globalplatform, the OBCs 0xE3 . . . 0xFA replace the OBCs of the “chip card”; in the package java.lang, all OBCs of the “chip card” are available; none are replaced, as the package java.lang replaces no OBCs.

B3: It is very important that all OBCs of a definition are a “block”, in this case 0xE3 . . . 0xFA. This is necessary for the VM, in order to find the right OBC in minimal time (complexity O(1)) and thus to keep the execution speed as high as possible.

C3: Within the class CConstants of the package com.gi_de.applets, these OBCs (0xD9 . . . 0xE0) are available.

Additionally, the OBCs of the package com.gi_de.applets within the class CConstants are available, but only 0xE1 . . . 0xF8, since 0xD9 . . . 0xE0 were replaced by those of the class CConstants.

Within CConstants, the “Card” OBCs 0xCB . . . 0xD8 and 0xF9 . . . 0xFD are also available.

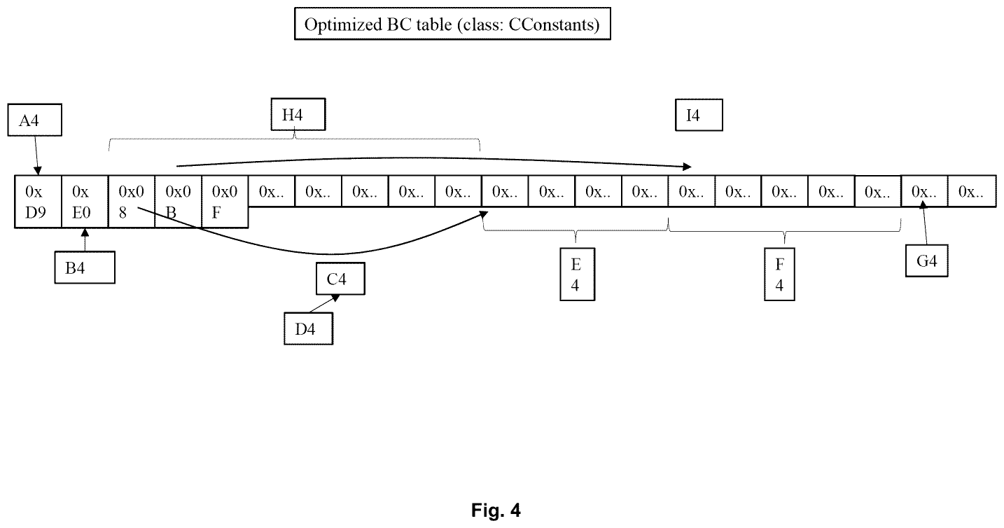

The allocation tables comprise “difference tables”. These contain bytecodes that afford only small memory space savings, which are replaced by bytecodes that permit a greater saving in the respective context. FIG. 4 shows such a difference table and illustrates the memory space efficiency.

With regard to memory space management, it would be impractical to store a complete allocation table for every context. The tables are therefore embodied as difference tables, which leads to their being much smaller. This table structure permits a fast check to determine whether a specific bytecode is included in the table, as depicted in FIG. 4.

The numbered references in FIG. 4 should be understood as follows:

A4: Index of the first bytecode included in this table.

B4: Index of the last bytecode included in this table.

C4: The first index is 8, and therefore 8 is added to the address of the index field in order to obtain the first OBC definition (0xD9).

D4: The reason for adding the index value to the address of the index field (instead of an absolute value from the start of the OBC table) is as follows: just one byte can be used to address a larger range.

E4: These bytes contain the optimized bytecode definition for 0xD9.

F4: These bytes contain the optimized bytecode definition for 0xDA.

G4: This is the start of the bytecode definition for 0xDB (and so on).

H4: Every byte is an offset from the respective optimized bytecode definition. The offset is added to the address of the index byte.

The index of the offset corresponds to the bytecode value.

Byte→bytecode 0xD9, 2nd byte→bytecode 0xDA . . . 8th byte→bytecode 0xE0

This method can be used to attain O(1) when accessing the fields of variable length in the bytecode definition.

14: The 2nd index is 0x0B, that is to say 11 is added to the address of the index field in order to obtain the second OBC definition (0xDA).

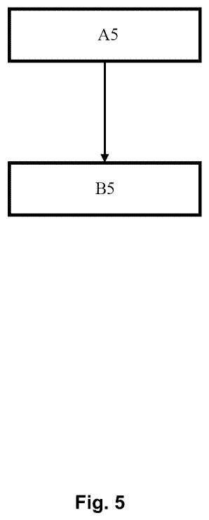

FIG. 5 depicts the method according to the invention for executing bytecode in a runtime environment and/or an applet of a smartcard. The numbered references shown here should be understood as follows:

A5: a free bytecode in a bytecode range that is unused according to the programming language specification is engaged with an implementation that depends on a context that the free bytecode is in,

B5: so as thereby to assign the free bytecode to a user-defined bytecode in order to achieve a memory space saving.

The presented approach of bytecode optimization affords a series of advantages. Using specific contexts and adjusting the bytecodes for these contexts achieves a high level of storage efficiency on the secure element, for example a chip card. This is made possible in particular through the use of “optimized bytecodes” and difference tables, which ensure efficient use of the available memory space.

Another advantage is the independence of the optimized bytecodes. This means that the bytecodes can be shaped individually by the operating system (OS) and applets, or between two arbitrary contexts. This increases flexibility considerably, since all components no longer need to be matched to one another exactly. They can be flexibly combined without difficulties, significantly simplifying generation of the operating system and of all customer variants.

The overhead, that is to say the additional memory space requirement of the optimized bytecodes, is also very low. This is clarified on the basis of an example: if only a single optimized bytecode is defined in an OBC table, only approximately 6-8 additional bytes are required. A memory saving is therefore achievable very quickly.

Finally, the approach affords the opportunity to combine multiple bytecodes into a single bytecode. This goes beyond merely reducing an unused bytecode to a standard bytecode. It opens up the potential for even greater storage efficiency and speed of execution by combining successive bytecodes in the operating system and applets into a single bytecode. This function merely requires the format of the “OBC definition” in the OBC table to be expanded.

These advantages together afford significant progress in the memory space optimization and flexibility of bytecode management on secure elements.

1. A secure element, that is configured to execute bytecode in a runtime environment and/or an applet, wherein the secure element is configured:
to engage a free bytecode in a bytecode range that is unused according to the programming language specification as a user-defined bytecode; and
to provide an allocation table for converting the user-defined bytecode into a standard bytecode sequence comprising at least one standard bytecode, according to the context of the use of the user-defined bytecode.

2. The secure element as claimed in claim 1, wherein the programming language is Java, wherein:
the unused bytecode range being a hexadecimal value range between 0xCA and 0xFF, wherein;
the user-defined bytecode being labelled as optimized bytecode due to the memory space saving; and/or
the secure element being a Java Card; and/or
the runtime environment being a Java runtime environment; and/or
the programming language specification being a Java specification.

3. The secure element as claimed in claim 1, wherein the context is defined by virtue of the bytecode being in an operating system of the secure element or in an applet loaded on the secure element.

4. The secure element as claimed in claim 1, wherein the context comprises a package that contains the bytecode, and/or
comprises a class to which the bytecode belongs, and/or
is determined by the type of a method that the bytecode is in, the method being an instance method, a constructor or a static method.

5. The secure element as claimed in claim 1, configured to use the allocation table to identify different contexts, including i) the operating system of the secure element, and/or ii) the applet, and/or iii) the package, and/or iv) the class and/or the type of the method, which permits a specific interpretation and implementation of the bytecode.

6. The secure element as claimed in claim 1, configured to carry out combined storage of the allocation table on the secure element, regardless of whether the actual storage location is in the memory area of the context, in order to permit faster access to bytecodes.

7. The secure element as claimed in claim 1, configured to provide a separate allocation table for each applet, given multiple applets, to improve memory use and to prevent incompatible combinations of the operating system and applets.

8. The secure element as claimed in claim 1, wherein the allocation table comprises difference tables in order to improve storage efficiency, changes in the bytecode assignments being detected relative to a master allocation table,
and/or the master allocation table is a fundamental table that comprises a set of user-defined bytecode assignments that is valid for different contexts, and/or
a difference table is designed to replace the user-defined bytecode for a subordinate context of the master allocation table with a bytecode that affords a greater memory space saving in the respective context.

9. The secure element as claimed in claim 1, wherein the difference table is in the form of a dense array, the dense array defining a first bytecode value and a last bytecode value, which is overwritten with regard to the next highest context, bytecode values in between likewise being overwritten.

10. The secure element as claimed in claim 1, wherein the dense array comprises elements that each have 1-byte indices that refer to a field in which the data for the user-defined bytecodes are stored, which implements an efficient redirection mechanism.

11. The secure element as claimed in claim 1, configured to use a prioritized assignment process, wherein, for a given context, the respective difference table for the bytecode assignment is first checked and, if no specific assignment is found, the master assignment table is used, which ensures an improved memory space saving within a context.

12. The secure element as claimed in claim 1, comprising a Java Card operating system or a native operating system,
the secure element being configured as a secure element module or as a chip card or as a smartcard or as a secure element module implemented in a housing having a different design than a secure element, wherein
the programming language being MULTOS Executable Language (MEL) or .NET Common Intermediate Language (CIL).

13. A method for executing bytecode in a runtime environment and/or an applet of a smartcard, wherein:
a free bytecode in a bytecode range that is unused according to the programming language specification is engaged as a user-defined bytecode, and an allocation table for converting the user-defined bytecode into a standard bytecode sequence comprising at least one standard bytecode is provided, the conversion taking place according to the context of the use of the user-defined bytecode.

14. A computer program or applet that carries out the method as claimed in claim 1 when it is loaded in a secure element and/or runs on the secure element.
